(19) United States
(12) Patent Application Publication
(10) Pub. No.: US 2025/0041789 A1
(43) Pub. Date: Feb. 6, 2025

(54) SIMULTANEOUS REMOVAL OF CARBON DIOXIDE, NOx and SOx USING SINGLE STAGE ABSORPTION COLUMN AND RELATED METHODS

(71) Applicant: Michigan Technological University, Houghton, MI (US)

(72) Inventors: Surendra Komar KAWATRA, Fort Meyers, FL (US); Sriram VALLURI, Grayslake, IL (US)

(21) Appl. No.: 18/715,978

(22) PCT Filed: Dec. 2, 2022
(86) PCT No.: PCT/US2022/051623

§ 371 Date: Jun. 3, 2024

Related U.S. Application Data
(60) Provisional application No. 63/285,887, filed on Dec. 3, 2021.

(51) Int. Cl. B01D 53/14; B01D 53/60; B01D 53/62

(52) U.S. Cl. CPC B01D 53/1481; B01D 53/1475; B01D 53/60; B01D 53/62; B01D 2251/606; B01D 2257/302; B01D 2257/402; B01D 2257/404; B01D 2257/504

(57) ABSTRACT

An absorption column for the simultaneous capture of the flue gases CO₂, NOₓ and SOₓ, the absorption column pertaining to a single wet scrubbing absorption column at alkaline pH conditions. In some aspects, the efficacy of the single stage absorption column for the simultaneous capture of the flue gases CO₂, NOₓ and SOₓ being at least 99% for CO₂, at least 30% for NO and at least 95% for SO₂. The single stage absorption column can have a sodium carbonate solution. The sodium carbonate solution can be enhanced by one or more oxidants as rate promoters, including H₂O₂, NaOCl and mixtures thereof.

### RELATED APPLICATIONS

This application is a National Phase entry of PCT Application No. PCT/US2022/051623 filed Dec. 2, 2022, which application claims the benefit of priority to U.S. Provisional Application No. 63/285,887 filed Dec. 3, 2021, the foregoing disclosures of which are incorporated herein by reference in their entirety.

### TECHNICAL FIELD

The present invention relates generally to the capture of contaminants from flue gas using an absorption column, particularly a single wet scrubbing absorption column at alkaline pH conditions for the simultaneous capture of CO₂, NOₓ and SOₓ from flue gas and methods of simultaneously capturing CO₂, NOₓ and SOₓ from flue gas.

### BACKGROUND

Flue gas emissions—the emitted material produced when fossil fuels such as coal, oil, natural gas, or wood are burned for heat or power—may contain pollutants, including carbon dioxide (CO₂), nitrogen oxides (NOₓ) and sulfur oxides (SOₓ). It is not believed that capture the pollutants CO₂, NOₓ and SOₓ together from flue gas has never been done before, but capturing them separately incurs a huge plant capital and operational costs.

Capturing flue gases from power plants is typically a multi-step process. This is usually done in three stages: (1) selective catalytic reduction (SCR) for the removal of NOx; (2) flue gas desulfurization (FGD) for the capture of SO₂ and (3) CO₂ capture. Capturing CO₂ separately from other gases is reported to require an additional 20% footprint for each capture unit operation, making it difficult for power plants with space constraints and also increasing the capital and operational costs for each individual unit operation. A study conducted by Li et al. (2016) at a 650-MW coal fired power plant concluded that the total cost of flue gas removal could be reduced by 13.1% by just integrating FGD and CO₂ capture into single stage.

The composition of NOx in flue gas has been reported to be mostly 90% inactive NO and the remainder NO₂. NO is problematic because it is typically very inactive in an absorbent solution and has very low water solubility. NO₂ dissolves readily in water, but NO must be oxidized to NO₂ in order to implement wet scrubbing processes. Oxidative absorbents, such as chlorine dioxide, boric acid, potassium permanganate (KMnO₄), hydrogen peroxide (H₂O₂) and several others have been tested in aqueous solutions to study the absorption kinetics of NO in water. Reagents such as sodium hypochlorite have good oxidizing properties at lower pH, which are converted to good absorbing properties at higher pH, due to high nucleophilic reactivities achieved under alkaline conditions. The majority of recent research has attempted to use these oxidizers alone at acidic pH in aqueous solutions where the reaction rate is higher at acidic pH and the rate progressively decreases at higher PH levels.

To date, minimal attempts have been made to combine all three processes into a single step. Santos et al. (2016) have previously proposed a method to capture all the three gases through chemical absorption with ozone as the oxidizing agent, but absorption efficiencies for all the three gases were never reported. While the combined removal of NOx and SOx has been previously studied, the combined removal has been performed under acidic pH conditions. Deshwal and Hyung-Keun (2009) were able to achieve SO₂ and NOx removal efficiencies of 100% and 70%, respectively, with the help of aqueous euchlorine, which is a significant removal. However, only the addition of an oxidant is not adequate for a system of flue gas with variable concentrations of CO₂, SO₂ and NOx.

Other studies have tried similar approaches for capturing NOx and SOx in a combined system before scrubbing CO₂. But the separate stages for the capture of NOx and SOx and then CO₂ can require additional capital and operating costs.

The absorption of CO₂ by carbonate solutions is limited at ambient temperature and is governed solely by the rate of physical mass transfer. Even at temperatures above 378 K, the reactions are not fast enough to make the absorption instantaneous. Therefore, the use of rate-enhancing agents such as piperazine (PZ), monoethanolamine (MEA), boric acid, carbonic anhydrase (CA), polyglycol ethers, hydrogen peroxide and sodium hypochlorite are of great importance. But some of these rate-enhancing agents have disadvantages, for example PZ and MEA are volatile and would make heat stable salts in presence of SO2. Enzymatic catalysts like carbonic anhydrase are very sensitive to presence of NOx and SOx hence not recommended in a combined capture system. Carbonic anhydrase also loses catalytic activity at temperatures greater than 314 K.

Therefore, there is a need in the industry for the simultaneous capture and removal of all three flue gases CO₂, NOₓ and SOₓ. There is also the need in the industry for combining the removal of CO₂, NOₓ and SOₓ into one step using non-toxic reagents, which would provide achieving further cost savings, making flue gas removal more economical and environment friendly.

### SUMMARY

In the present invention, CO₂, NOₓ and SOₓ can be simultaneously captured from flue gas with a single wet scrubbing column. In some aspects, the absorption of all three gases with a scrubbing solution comprising a sodium carbonate solution promoted with at least one oxidizer can be conducted using a single stage absorption column.

In some aspects, CO₂, NOₓ and SOₓ can be simultaneously captured from flue gas in a single stage absorption unit at alkaline pH conditions. In some preferred aspects, the single stage absorption unit comprises a single wet scrubbing column.

In some aspects, the absorbance is at least 95%, in some aspects at least 97%, in some aspects at least 99%, in some aspects at least 99.1%, in some aspects at least 99.2%, in some aspects at least 99.3%, in some aspects at least 99.4%, in some aspects at least 99.5%, in some aspects at least 99.6%, in some aspects at least 99.7%, in some aspects at least 99.8%, in some aspects at least 99.9%, and in some aspects 100% for CO₂.

In some aspects, the absorbance is at least 25%, in some aspects at least 26%, in some aspects at least 27%, in some aspects at least 28%, in some aspects at least 29%, and in some aspects at least 30% for NO.

In some aspects, the absorbance is at least 90%, in some aspects at least 91%, in some aspects at least 92%, in some aspects at least 93%, in some aspects at least 94%, and in some aspects at least 95% for SO₂.

In some aspects, the absorbance is at least about 95% for CO₂, at least about 25% for NO, and at least about 90% for SO₂, in some aspects at least about 97% for CO₂, at least about 26% for NO, and at least about 91% for SO₂, in some aspects at least about 98% for CO₂, at least about 27% for NO, and at least about 92% for SO₂, in some aspects at least about 99% for CO₂, at least about 28% for NO, and at least about 92% for SO₂, in some aspects at least about 99.2% for CO₂, at least about 28.5% for NO, and at least about 92.5% for SO₂, in some aspects at least about 99.5% for CO₂, at least about 29% for NO, and at least about 93% for SO₂, and in some preferred aspects at least about 99.7% for CO₂, at least about 29.5% for NO, and at least about 94.5% for SO₂.

In some aspects, the absorbance is up to about 100% for CO₂, up to about 50% for NO, and up to about 99% for SO₂, in some aspects up to about 100% for CO₂, up to about 45% for NO, and up to about 98% for SO₂, in some aspects up to about 100% for CO₂, up to about 40% for NO, and up to about 97% for SO₂, and in some other aspects up to about 100% for CO₂, up to about 35% for NO, and up to about 97.5% for SO₂,

In some aspects, the single stage absorption unit at alkaline pH conditions comprises a counter-current absorption column.

In some aspects, the single stage absorption unit at alkaline pH conditions comprises a scrubbing solution.

In some aspects, the scrubbing solution comprises a sodium carbonate solution. In some preferred aspects, the scrubbing solution comprises a sodium carbonate solution having a concentration greater than 0.1 mol/L up to 1 mol/L, preferably between about 0.1 mol/L and about 0.8 mol/L, and more preferably between about 0.1 mol/L and about 0.4 mol/L.

In some aspects, the scrubbing solution comprises a sodium carbonate solution and at least one oxidizer. In some aspects, the capture efficiency of sodium carbonate solution is increased up to about 40% for CO₂ loading, with the addition of the at least one oxidizer.

In some aspects, the absorption efficiency of the sodium carbonate solution is increased by the addition of H₂O₂, NaOCl or a mixture thereof. In some aspects, the absorption efficiency of the sodium carbonate solution is increased by the addition of H₂O₂. In some aspects, the absorption efficiency of the sodium carbonate solution is increased by the addition of NaOCl.

In some preferred aspects, the at least one oxidizer is present in the scrubbing solution in an amount between about 100 μL/L and about 1500 μL/L, in some aspects preferably between about 500 μL/L and about 1000 μL/L, and in some aspects more preferably between about 650 μL/L and about 850 μL/L.

In some aspects, the sodium carbonate solution is provided at a pH in the rage of about 8 to about 13, in some aspects about 9 to about 12.5, in some aspects about 10 to about 12.2, and in some preferred aspects about 11 to about 12.

In some aspects, an inlet temperature of flue gas comprising CO₂, NOₓ and SOₓ into the single stage absorption unit is between about 32° C. and about 52° C., preferably between about 34° C. and about 50° C., more preferably between about 36° C. and about 48° C.

In some aspects, a ratio of the scrubbing solution to flue gas in the single stage absorption unit is between about 2 to about 5, preferably between about 3 and about 4.8, more preferably between about 4 and about 4.6.

In some aspects, a scrubbing solution flow rate is between about 1 gallon/minute and about 5 gallons/minute, preferably between about 1.25 gallons/minute and about 4 gallons/minute, more preferably between about 1.5 gallons/minute and about 2.5 gallons/minute.

In some aspects, the single stage absorption unit comprises a packing material.

In some aspects, the packing material comprises pall rings.

In some aspects, the pall rings comprise polypropylene, polyvinylidene fluoride (PVDF), high-density polyethylene (HDPE), glass filled polypropylene, polyvinyl chloride (PVC), and combinations thereof.

In some aspects, the scrubbing solution is essentially devoid of a rate-enhancing agent chosen from piperazine (PZ), monoethanolamine (MEA), boric acid, carbonic anhydrase (CA) and polyglycol ethers.

In some aspects, the present invention comprises a scrubber system for the removal of CO₂, NOₓ and SOₓ from flue gas. In some preferred aspects, the scrubber system comprises a single stage absorption column comprising a scrubbing solution comprising a sodium carbonate solution promoted with at least one oxidizer. In some aspects, the scrubber system comprises a second scrubbing column in series after the single stage absorption column, wherein the second scrubbing column is configured for removal of a remaining amount of NOₓ from the single stage absorption column. In some aspects, the scrubber system comprises a primer scrubbing column in series prior to the single stage absorption column, wherein the primer scrubbing column is configured for removal of an initial amount of NOₓ from the flue gas. In some aspects, the second scrubbing column and/or the primer scrubbing column comprises a selective catalytic reduction scrubbing column.

In some aspects, the present invention comprises a method for the simultaneous removal of CO₂, NOₓ and SOₓ from flue gas using a single stage absorption unit having a scrubbing solution comprising sodium carbonate solution and at least one oxidizer at an alkaline pH.

The method, scrubber system and apparatus, including the single stage absorption unit and/or scrubbing solution, disclosed and claimed herein can comprise, consist of, or consist essentially of the essential elements and limitations of the method, scrubber system and apparatus described herein.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a schematic of the dimensions of a pilot scale single stage absorption capture column for the simultaneous capture of CO₂, NOₓ and SOₓ from flue gas.

FIG. 2 is a graph illustrating the absorbance of CO₂ versus time in 0.2 mol/L Na₂CO₃ solution and the various concentrations of H₂O₂/NaOCl at 318 K, with the error bars representing standard error (n=3).

FIG. 3 is a graph illustrating rate constant with respect to concentration for CO₂ absorbance in 0.2 mol/L Na₂CO₃ solution and an H₂O₂/NaOCl solution, with the error bars representing standard error (n=3).

FIG. 4 is a graph illustrating the absorbance of NO versus time in 0.2 mol/L Na₂CO₃ solution and various concentrations of H₂O₂ at 318 K, with the error bars representing standard error (n=3).

FIG. 5 is a graph illustrating the absorbance of NO versus time in 0.2 mol/L Na₂CO₃ solution and various concentrations of NaOCl at 318 K, with the error bars representing standard error (n=3).

FIG. 6 is a graph illustrating the effect of oxidizer concentration on the absorbance rate of NO at 318 K.

FIG. 7 is a graph illustrating the absorbance of SO₂ versus time in 0.2 mol/L Na₂CO₃ solution and various concentrations of H₂O₂/NaOCl at 318 K, with the error bars representing standard error (n=3).

FIG. 8 is a graph illustrating the absorbance of CO₂, NO and SO₂ versus pH with 750 μ/L H₂O₂ concentration at 318 K at 5 minute intervals, with the error bars representing standard error (n=3).

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The present inventors have simultaneously captured CO₂, NOₓ and SOₓ from flue gas with a single wet scrubbing column. The absorption of all three gases was achieved using a scrubbing solution comprising sodium carbonate solution promoted with one or more oxidizers in a single stage absorption column.

In the present disclosure, the oxidant is chosen from the oxidizers consisting of H₂O₂, NaOCl, NaOCl₂, and NaClO₃. In some preferred aspects, the oxidant is H₂O₂, NaOCl, or a mixture thereof. H₂O₂ is a very strong oxidizer and has high nucleophilic reactivity for carbonyl carbon. While H₂O₂ is a very strong oxidizing agent, it is also more expensive than other oxidizers. Thus, substituting at least a portion of the H₂O₂ with NaOCl can reduce the reagent cost. In some aspects, NaOCl is preferred over NaClO2 and NaClO3 based on the previous observations that ClO— acts as a better nucleophile compared to the other two species.

The present inventors have examined the absorption efficiency of sodium carbonate solution promoted with hydrogen peroxide (H₂O₂) and sodium hypochlorite (NaOCl) on NO, CO₂ and SO₂ under alkaline conditions, including the pH range from about 10.6 to about 11.8. This process with respect to NO is similar to selective non-catalytic reduction (SNCR) at ambient temperature. While sodium carbonate displays slower absorption kinetics for CO₂ absorption compared to traditional amines, adding these rate promoters can enhance the absorption kinetics greatly making its absorption performance surpass that of amines. SO₂ is instantaneously absorbed into aqueous sodium carbonate solutions. One of the unique aspects of the present invention is that the inventors have surprisingly discovered successful absorption of NO, CO₂ and SO₂ gases with a single stage absorption column of sodium carbonate supported with H₂O₂/NaOCl.

The absorption kinetics of both H₂O₂ and NaOCl with all three gases were individually studied. The absorption characteristics of a combined gas system for NO, CO₂ and SO₂ gases and how the absorption kinetics of each individual gas is affected by the rate promoter are also disclosed further herein.

Without wishing to be bound by theory, the reason for adding rate promoters for post combustion CO₂ capture is that sodium carbonate has slower kinetics compared to amines and other alkali absorbents like NaOH. There are several rate promoters that will increase the kinetics as well as aid in using low concentrations of the reagents by achieving high mass transfer ratio in less time.

### CO₂ Absorption in Aqueous Solution

When CO2 is introduced in aqueous solution, the first step is hydration where gas phase CO2 is transferred to liquid phase CO2 then it forms carbonic acid, which reacts with sodium carbonate to form sodium bicarbonate. The reaction between sodium carbonate and CO2 are shown in Eqs. (1)-(4) below:

Na₂CO₃₍ₛ₎+H₂O₍ₗ₎+CO_{2(g)}→2NaHCO_{3(aq)} (1)

Eq. (1) represents the overall reaction between aqueous sodium carbonate and CO₂ forming sodium bicarbonate, with the following reaction Intermediates.

CO_{2(g)}═CO₂₍ₗ₎ (2)

CO₂₍ₗ₎+H₂O═H⁺+HCO⁻₃ (3)

HCO⁻₃═H⁺+CO₃²⁻ (4)

Step (3) is the slowest and rate determining step, so adding a rate promoter would enhance the reaction kinetics and improve the absorption efficiency of carbonate solution. Also, the rate of reaction of CO₂ in alkaline solutions follow first order kinetics. Enhancing the reaction kinetics for CO₂ absorption in carbonate solution can be done with the help of several rate promoters like vanadate, hypochlorite, piperazine, etc. Boric acid, arsenous acid and MEA are among other homogeneous rate enhancing reagents previously explored. Arsenous acid gave very good performance for increasing absorption kinetics of CO₂ hydration, but due to toxic and carcinogenic effects of arsenite it is no longer explored as a rate promoter for CO₂ capture. Other reagents like piperazine and boric acid do not have oxidative properties like hypochlorite to enhance NO absorption.

### NO Absorption in Aqueous Solution

NO has very low solubility in water (0.0056 mg/100 mL at 293 K). While NO₂ hydrolyses readily in water, if NO can be oxidized to NO₂ then it can be easily absorbed into aqueous solutions. There are several oxidizing agents like H₂O₂, NaClO, NaClO₂, KMnO₄ etc. Other absorbents include Na₂SO₃, FeSO₄, EDTA and urea. Most of the reactions follow first order kinetics. Many of these reagents have disadvantages pertaining to mixed gas system. For example, the use of potassium permanganate has been known to produce brown precipitates, due to the formation of manganese dioxide. These precipitates clog the packing material in the scrubbing column, and also causes problems in the pumping system. Urea has dormant activity for CO₂ and SO₂. NO absorption in aqueous solutions after being oxidized to NO₂ is shown below and the overall reaction of NO and H₂O₂ in the aqueous phase is as follows in Equations 5 and 6:

NO+H₂O₂→NO₂+H₂O (5)

2NO₂+H₂O→HNO₃+HNO₂ (6)

The reactions scheme with NaOCl is as follows in Equations 7-8:

NO+NaOCl→NO₂+NaCl (7)

3NO₂+H₂O→2HNO₃+NO (8)

2NO₂+H₂O→HNO₃+HNO (9)

### SO₂ Absorption in Aqueous Solution:

Although different methods have been proposed over the years, wet scrubbing process is the commonly used process for removing SO₂ from flue gas. The following reaction pathways 10-13 should be considered when sulfur dioxide is introduced into aqueous solutions of NaHCO₃/Na₂CO₃:

SO₂+H₂O═H++HSO⁻₃ (10)

HSO⁻₃═H⁺+SO²⁻₃ (11)

H₂O═H⁺+OH⁻ (12)

HCO⁻₃═H⁺+CO²⁻₃ (13)

Reaction (10) has very fast kinetics, with a forward rate constant reported as 3.40×10⁶ sec⁻¹. Reactions (11) and (12) can be regarded as almost instantaneous, since they are based on simple transfer of H+. The mass transfer coefficient of SO₂ in aqueous solutions is correlated to temperature and with increase in temperature it increases, at the operating temperature of around 318 K the mass transfer coefficient of SO₂ in aqueous solution is reported to be two times higher than at 293 K. Owing to high mass transfer coefficient and instantaneous reactions, SO₂ can be absorbed readily into sodium carbonate solution with or without the presence of rate enhancing reagents.

### Kinetic Measurements

Dankwerts surface renewal model is the widely accepted kinetic model for the absorption of gases in liquid solutions. Based on the Danckwerts film renewal model the rate of absorption of NO is given by Equation 14:

$${N}_{NO} = kg / RT ( {p}_{NO} - {p}_{NOi} ) \qquad ( 14 )$$

where R is universal gas constant, kg (m/sec) is gas phase mass transfer coefficient, T is the temperature and ^{p}_{NO} is partial pressure of NO. ^{p}_{NOi} is the interfacial pressure of NO in the aqueous solution that can be obtained by Henry's law given by Equation 15:

$${p}_{{NO}_{i}} = {H}_{NO} {C}_{NO} \qquad ( 15 )$$

where, H_{NO} (Pa·m³/mol) is Henry's law constant, C_{NO} (mol/m³) is the concentration of NO at the gas-NaClO/Na₂CO₃ solution interface, and is directly associated with the solution's ionic strength. This relationship is shown in the following expression of Equation 16:

$$log ( {C}_{NO} / CNOW = - ( {k}_{NaClO} {I}_{NaClO} + {k}_{OH} - {I}_{OH} - ) \qquad ( 16 )$$

where k_{NaClO} and k_{OH}_{^{−}} are the salting-out parameters of NaClO and OH⁻, respectively, I (mol/L) is the ionic strength of the solution, and C_{NOW} (mol/m³) is the interfacial concentration of NO at the gas-water interface. The salting out parameters of an electrolyte solution can be obtained by adding their anion, cation and gas contribution numbers respectively, as shown in Equation 17 below.

$$k = {x}_{a} + {x}_{c} + {x}_{g} \qquad ( 17 )$$

where xₐ is contribution by anions, x_{c} is contribution by cations and x_{g} by gas, respectively in mol/L. One of ordinary skill in the art will appreciate that the individual x values can be identified from previous literature. But, x_{ClO}_{^{−}} is not mentioned in the literature so it is presumed that the role of hypochlorite ion is the same as that of the reported chlorite i.e. x_{ClO}_{^{−}}=0.3497. The rate at which CO₂ is absorbed into carbonate solutions can be described as follows in Equation 18:

$${R}_{CO 2} = dc / dt = {k}_{L} a ( c * - c ) = k [ {CO}_{2} ] \qquad ( 18 )$$

where k_{L} is mass transfer coefficient, a is gas-liquid interfacial area, c* is CO₂ concentration at saturation i.e. the solubility of CO₂, c is bulk concentration of CO₂ dissolved, and k is the rate constant assuming first order kinetics. The percentage concentration of gases going in and out of the scrubbing column is continuously monitored by the gas analyzer. The absorption efficiency (AE, %) or percentage of absorbance (PA, %) for each gas (CO₂, NO and SO₂) is calculated individually by the following Equation 19:

$$AE = PA = ( Y in - Y out ) / Y in \times 100 \% \qquad ( 19 )$$

where Yin is number of moles of the gas going into the scrubbing column and Yout is number of moles of the gas coming out of the scrubbing column.

In the present invention, CO₂, NOₓ and SOₓ can be simultaneously captured from flue gas with a scrubbing unit comprising a scrubbing solution. The absorption of CO₂, NOₓ and SOₓ from glue gas can be achieved using a single stage absorption unit comprising a scrubbing solution, the scrubbing solution preferably comprising a sodium carbonate solution promoted with at least one oxidizer.

The single stage absorption unit preferably comprises a single wet scrubbing column, more preferably a counter-current absorption column.

In some preferred aspects, the scrubbing solution comprises a sodium carbonate solution having a concentration greater than 0.1 mol/L up to 1 mol/L, preferably between about 0.1 mol/L and about 0.8 mol/L, and more preferably between about 0.1 mol/L and about 0.4 mol/L. In some preferred aspects, an optimal concentration of the sodium carbonate solution is between about 0.15 mol/L and about 0.25 mol/L.

The absorption efficiency of the sodium carbonate solution in simultaneously capturing CO₂, NOₓ and SOₓ can be increased by the scrubbing solution also comprising at least one oxidizer. In some aspects, the at least one oxidizer is chosen from the group consisting of H₂O₂, NaOCl, NaOCl₂, NaClO₃, and mixtures thereof. In some preferred aspects, the at least one oxidizer is H₂O₂, NaOCl, or a mixture thereof. In some preferred aspects, the absorption efficiency of the sodium carbonate solution is increased by the addition of H₂O₂ as the oxidizer. In some other preferred aspects, the absorption efficiency of the sodium carbonate solution is increased by the addition of NaOCl as the oxidizer.

In some preferred aspects, the at least one oxidizer is present in the scrubbing solution in an amount between about 100 μL/L and about 1500 μL/L, in some aspects preferably between about 500 μL/L and about 1000 μL/L, and in some aspects more preferably between about 650 μL/L and about 8500 μL/L.

In some preferred aspects, the at least one oxidizer comprises H₂O₂, NaOCl, or a mixture thereof, which is present in the scrubbing solution in an amount between about 100 μL/L and about 1500 μL/L, in some aspects preferably between about 500 μL/L and about 1000 μL/L, and in some aspects more preferably between about 650 μL/L and about 8500 μL/L.

The sodium carbonate solution preferably has a pH in the range between about 8 and about 13, in some aspects between about 9 and about 12.5, in some aspects between about 10 and about 12.2, and in some preferred aspects between about 11 and about 12.

According to some aspects, the absorbance of CO₂ is at least 95%, in some aspects at least 97%, in some aspects at least 99%, in some aspects at least 99.1%, in some aspects at least 99.2%, in some aspects at least 99.3%, in some aspects at least 99.4%, in some aspects at least 99.5%, in some aspects at least 99.6%, in some aspects at least 99.7%, in some aspects at least 99.8%, in some aspects at least 99.9%, and in some aspects 100%, of the flue gas entering the scrubbing unit.

In some aspects, the absorbance of NO is at least 25%, in some aspects at least 26%, in some aspects at least 27%, in some aspects at least 28%, in some aspects at least 29%, and in some aspects at least 30%, of the flue gas entering the scrubbing unit.

In some aspects, the absorbance of SO₂ is at least 90%, in some aspects at least 91%, in some aspects at least 92%, in some aspects at least 93%, in some aspects at least 94%, and in some aspects at least 95%, of the flue gas entering the scrubbing unit.

In some aspects, the absorbance of the flue gas entering the scrubbing unit is at least about 95% for CO₂, at least about 25% for NO, and at least about 90% for SO₂, in some aspects at least about 97% for CO₂, at least about 26% for NO, and at least about 91% for SO₂, in some aspects at least about 98% for CO₂, at least about 27% for NO, and at least about 92% for SO₂, in some aspects at least about 99% for CO₂, at least about 28% for NO, and at least about 92% for SO₂, in some aspects at least about 99.2% for CO₂, at least about 28.5% for NO, and at least about 92.5% for SO₂, in some aspects at least about 99.5% for CO₂, at least about 29% for NO, and at least about 93% for SO₂, and in some preferred aspects at least about 99.7% for CO₂, at least about 29.5% for NO, and at least about 94.5% for SO₂.

In some aspects, the absorbance of the flue gas entering the scrubbing unit is up to about 100% for CO₂, up to about 50% for NO, and up to about 99% for SO₂, in some aspects up to about 100% for CO₂, up to about 45% for NO, and up to about 98% for SO₂, in some aspects up to about 100% for CO₂, up to about 40% for NO, and up to about 97% for SO₂, and in some other aspects up to about 100% for CO₂, up to about 35% for NO, and up to about 97.5% for SO₂,

In some aspects, an inlet temperature of flue gas comprising CO₂, NOₓ and SOₓ entering the scrubbing unit, preferably the single stage absorption unit, is between about 32° C. and about 52° C., preferably between about 34° C. and about 50° C., more preferably between about 36° C. and about 48° C.

In some aspects, a ratio of the scrubbing solution to flue gas in the single stage absorption unit is between about 2 to about 5, preferably between about 3 and about 4.8, more preferably between about 4 and about 4.6.

In some aspects, a scrubbing solution flow rate is between about 1 gallon/minute and about 5 gallons/minute, preferably between about 1.25 gallons/minute and about 4 gallons/minute, more preferably between about 1.5 gallons/minute and about 2.5 gallons/minute.

The single stage absorption unit preferably also comprises a packing material. In some aspects, the packing material comprises pall rings. The pall rings can comprise polypropylene, polyvinylidene fluoride (PVDF), high-density polyethylene (HDPE), glass filled polypropylene, polyvinyl chloride (PVC), and combinations thereof. In some preferred aspects, the packing material comprises polypropylene pall rings.

The scrubbing solution is preferably essentially devoid of other rate-enhancing agents, including piperazine (PZ), monoethanolamine (MEA), boric acid, carbonic anhydrase (CA) and polyglycol ethers.

In some aspects, the present invention comprises a scrubber system for the simultaneous removal of CO₂, NOₓ and SOₓ from flue gas. In some preferred aspects, the scrubber system comprises a single stage absorption column and a scrubbing solution within the single stage absorption column, wherein the scrubbing solution comprises a sodium carbonate solution promoted with at least one oxidizer.

In some aspects, the scrubber system comprises a second scrubbing column in series after the single stage absorption column, wherein the second scrubbing column is configured for removal of a remaining amount of NOₓ from the single stage absorption column.

In some aspects, the scrubber system comprises a primer scrubbing column in series prior to the single stage absorption column, wherein the primer scrubbing column is configured for removal of an initial amount of NOₓ from the flue gas.

In some aspects, the second scrubbing column and/or the primer scrubbing column comprises a selective catalytic reduction scrubbing column.

In some aspects, the present invention comprises a method for the simultaneous removal of CO₂, NOₓ and SOₓ from flue gas using a single stage absorption unit having a scrubbing solution comprising sodium carbonate solution and at least one oxidizer. The method includes providing a scrubbing unit comprising a single stage absorption unit having a scrubbing solution therein, the scrubbing solution comprising a sodium carbonate solution promoted with at least one oxidizer. Flowing flue gas comprising CO₂, NOₓ and SOₓ through the scrubbing unit. In some preferred aspects, the scrubbing solution has a flow in an opposite direction of the flue gas, such that the scrubbing unit is used as a counter-current absorption unit. In some preferred aspects, the scrubbing solution is continuously fed into the single stage absorption unit at an opposite end as the flue gas, such that clean gas exits the same end as the scrubbing solution being entered into the single stage absorption unit.

In some preferred aspects, scrubbing solution is provided at an alkaline pH. The sodium carbonate solution preferably has a pH in the range between about 8 and about 13, in some aspects between about 9 and about 12.5, in some aspects between about 10 and about 12.2, and in some preferred aspects between about 11 and about 12.

An inlet temperature of flue gas comprising CO₂, NOₓ and SOₓ entering the scrubbing unit, preferably the single stage absorption unit, is between about 32° C. and about 52° C., preferably between about 34° C. and about 50° C., more preferably between about 36° C. and about 48° C.

A ratio of the scrubbing solution to flue gas in the single stage absorption unit is between about 2 to about 5, preferably between about 3 and about 4.8, more preferably between about 4 and about 4.6.

A scrubbing solution flow rate is between about 1 gallon/minute and about 5 gallons/minute, preferably between about 1.25 gallons/minute and about 4 gallons/minute, more preferably between about 1.5 gallons/minute and about 2.5 gallons/minute.

The single stage absorption unit preferably also comprises a packing material. In some aspects, the packing material comprises pall rings. The pall rings can comprise polypropylene, polyvinylidene fluoride (PVDF), high-density polyethylene (HDPE), glass filled polypropylene, polyvinyl chloride (PVC), and combinations thereof. In some preferred aspects, the packing material comprises polypropylene pall rings.

### Example

### Materials and Methods

### Column Properties

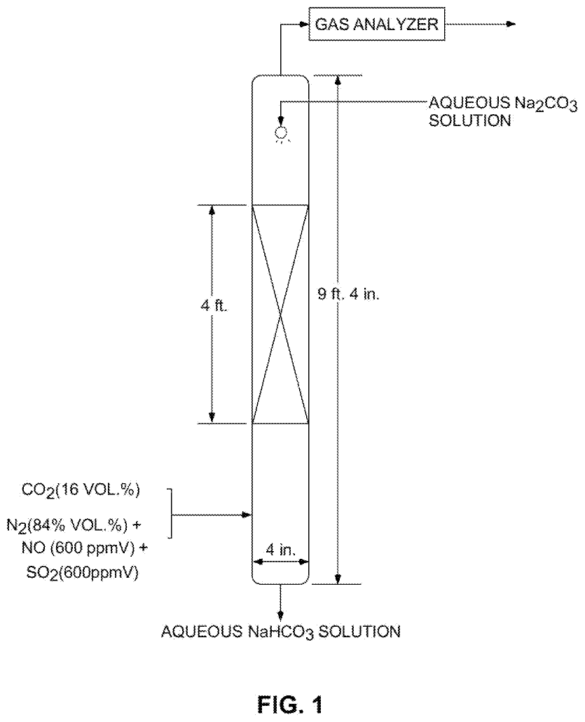

A CO₂ capture column has been designed and built as shown in FIG. 1. The packing material used to fill the scrubber column is polypropylene pall rings 0.5 inch×0.5 inch. The height of a packed bed scrubbing column (Z) is calculated using the contact tower design equation (Equation 20 below). Gₛ represents molar flow of solute-free gas per cross-sectional area of the column. a is the interfacial area available for mass transport. K_{y} accounts for overall gas phase mass transfer coefficient. Y is the fraction of moles of gas phase solute per moles of solute-free gas, and Y* denotes the gas phase mole fraction in equilibrium with the liquid phase. The denominator of the integral represents the driving force for mass transfer and is integrated over the condition of the gas phase from the top to the bottom of the column.

$$Z = \frac{{G}_{s}}{{K}_{y} \times a} \begin{matrix}{Y}_{1} \\ {{Y}_{2}}^{\int }\end{matrix} \frac{dY}{Y - {Y}^{⋆}} \qquad ( 20 )$$

Given that the interfacial area a is in the denominator of the design equation, it is advantageous to have a large amount of interfacial area within the scrubbing column. This is the reason most scrubbing columns are filled with packing.

### Experimental

The pilot scale scrubbing column shown in FIG. 1 was used to conduct experiments on absorbance of CO₂, NO and SO₂ with sodium carbonate solution in the presence of oxidizer. The top portion of the capture column (7 ft) is made of transparent poly acrylic plastic, and the bottom portion is made of steel to ensure robustness. The packed-bed absorption column (Packing: Polypropylene pall rings 0.5 inch×0.5 inch) in FIG. 1 is used as a counter-current absorption column, where flue gas enters from the bottom of the column, then the gas flows up through the packed bed where it contacts the scrubbing liquid. The scrubbing liquid removes the contaminant and exits out the bottom. Clean gas then exits out from top of the column. In order to simulate the flue gas, a gaseous mixture containing 16 vol. % CO₂, 600 ppmV NO, 600 ppmV SO₂ and remainder nitrogen was continuously fed into the bottom of the scrubbing column with the help of a gas diffuser.

For the absorption experiments, Na₂CO₃ (99.8% pure) was obtained from Genesis Alkali, H₂O₂ and NaOCl (reagent grade) were obtained from Sigma-Aldrich. All gas cylinders were obtained from Air-products. Gas flow rate was maintained at 21 L/min. Gas flow rates were measured with gas flow meters (Model 7520, OMEGA, USA) equipped with gas controllers (Model 316, McMaster-Carr, USA). Separate flow meters were installed for the mixed gases to measure the volumetric flow and to control the percentage of CO₂ in the gas stream. Stainless steel is suggested for the column and piping to avoid any equipment corrosion due to caustic pH.

The composition of gases exiting out from the top of the column is measured with a Nova Multi-Gas Analyzer fitted with nondispersive infrared (NDIR) and electrochemical sensors, calibrated with CO₂/NO/SO₂/N₂ reference gases. A range of concentrations for the oxidizer (H₂O₂/NaOCl) starting from 500 to 1500 μL/L were tested. The pH measurements were taken at regular intervals with Oakton handheld pH meter. The percentage of absorbance data was continuously recorded by the data logger connected to the gas analyzer. After each experiment the data logger was connected to the computer and the graph generated from it was integrated to calculate the total moles of CO₂ absorbed per minute for measuring the kinetic data. The accuracy of the data was ensured by repeating these experiments in triplicates. The operating conditions of the column shown in FIG. 1 were: liquid/gas-ratio 4.3, scrubbing solution flowrate 2 gallons/min, gas inlet temperature 313 K, scrubbing solution inlet temperature 318 K, gas composition 16 vol. % CO₂, 600 ppmV NO, 600 ppmV SO₂, and rest N₂.

### Results and Discussion

Along with replacing three stage flue gas capture with single stage, it is also an aim of the present invention at reducing the reagent costs by switching from amines to dilute sodium carbonate solution enhanced with rate promoters. CO₂ capture with dilute sodium carbonate solution was first disclosed in U.S. Pat. No. 7,919,064. Later there were several improvements made for this process, most recently in Barzagli et al. (2017) having tested dilute sodium carbonate solution for CO₂ capture and were able to achieve 80% CO₂ absorption efficiency. The present inventors have tested various concentrations of sodium carbonate solution ranging from 0.1 to 0.4 mol/L with the addition of H₂O₂/NaOCl ranging from 500 to 1000 μL/L. Starting with a 50-gallon solution, the scrubbing solution was recycled through the scrubber for a total duration of 87 min before it is completely loaded with bicarbonate. After performing several experiments, the optimum concentration was noted to be 0.2 mol/L Na₂CO₃ solution+750 μL/L H₂O₂, achieving 99.7% absorbance for CO₂, 31% for NO and 97% for SO₂ respectively. The experimental uncertainty is calculated and the error bars are plotted within the 95% confidence interval. These results, along with reaction kinetics are discussed in detail in further sections.

### CO₂ Absorption

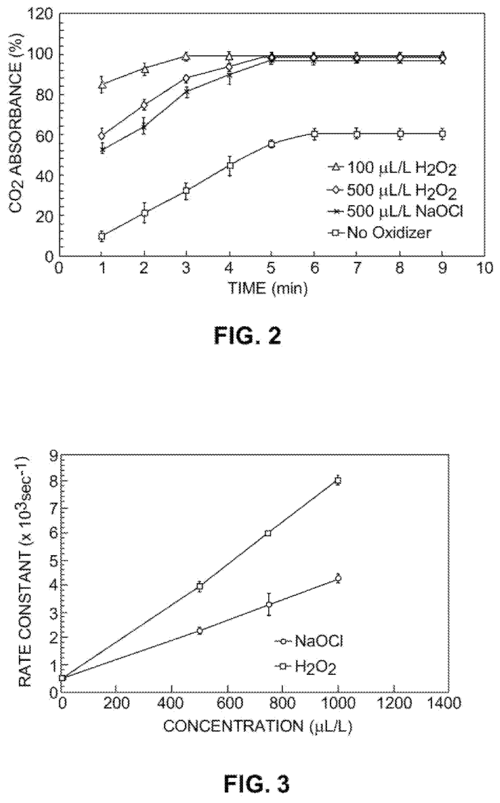

Curves in FIG. 2 show the absorbance of CO₂ in 0.2 mol/L Na₂CO₃ solution enhanced with H₂O₂/NaOCl. The percentage of absorbance (%) reached 80% in the first 1 min with the addition of H₂O₂/NaOCl and finally reaching 99.7% in 5 min after reaching steady state. The absorbance with Na₂CO₃ solution alone is only 61%, but after the addition of oxidizer the absorbance increased to 100%. The rate of absorption increased with increasing H₂O₂ and NaOCl concentrations. Initially with increase in concentration of the oxidizer from 500 to 1000 μL/L showed increased kinetics of CO₂ absorption, but after reaching steady state in 5 min, 750 and 1000 μL/L oxidizer gave almost similar absorption efficiency, with 1000 μL/L concentration showing 0.2% higher absorption than 750 μL/L. While performing the experiment, the inventors observed effervescence in the liquid solution, though barely visible. In addition to potential chemical kinetic effects, the effervescence is believed to have led to additional bubble formation, increasing the mass transfer area of contact between the gas and the liquid. In Equation 18 increasing the interfacial area (a) will increase the absorption rate.

### CO₂ Absorption Kinetics

The reaction intermediates for CO₂ absorption into sodium carbonate solution are given below (Steps (2)-(4)). Step (3) is the rate determining step, since the rest of the reactions are almost instantaneous.

CO_{2(g)}=CO₂₍ₗ₎ (Step 2)

CO₂₍ₗ₎+H₂O═H₊+HCO⁻₃ (Step 3)

HCO₋₃=H₊+CO²₃. (Step 4)

Adding a small amount of rate promoters can enhance the CO₂ absorption capacity of carbonate solutions significantly at lower temperatures. Since CO₂ is a Lewis acid, Lewis bases with O⁻ or OH groups can act as rate promoters. The enhanced CO₂ absorption rate in FIG. 2 can be attributed to the rate enhancing activity of H₂O₂/NaOCl on the equilibrium rate determining reaction (Step 3). The time required to establish equilibrium was reduced after the addition of H₂O₂/NaOCl. Whether its organic or inorganic additive, both follow a mechanism suggested by the Astarita equation as shown below in Equations 21 and 22:

CO₂+Promoter→Intermediate (21)

Intermediate+OH₋→HCO₃₋+Promoter (22)

For the homogeneous activity with H₂O₂ and NaOCl, carbonyl carbon acts as the substrate. This reaction scheme can be seen below. In case of homogeneous catalysis in the presence of H₂O₂/NaOCl, step (22) follows step (21) immediately. In a broader view these additives do not undergo any major chemical transformation, but rather increase the overall mass transfer phenomenon. Reaction mechanisms can be seen in Schemes 1 and 2 based on the alpha effect theory proposed by Edwards and Pearson (1962).

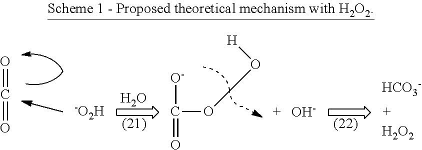

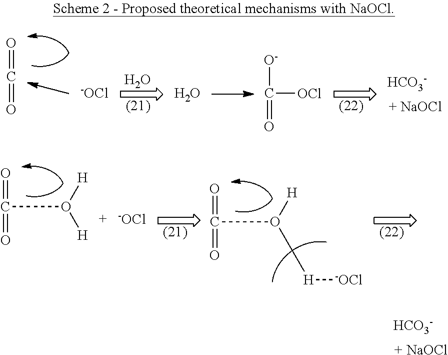

Rate of reaction was estimated by calculating the slope of number of moles of CO₂ absorbed vs time. Number of moles absorbed was calculated by performing trapezoidal integration on the graph generated by the data logger on the gas analyzer. The rate constant shown in FIG. 3 was estimated from the rate of reaction in Eq. (18) assuming first order kinetics. The observed rate constant represents that H₂O₂ is a better homogeneous catalyst than NaOCl. In alkaline pH conditions certain nucleophiles like peroxide and hypochlorite react very rapidly. This nucleophilic substitution is described as “Alpha Effect” by Edwards and Pearson (1962). In this scenario, carbonyl carbon acts as the substrate, so under these conditions the rate constants (rate constants of H₂O₂ 2×10₅ mol₋₁min₋₁, rate constants of NaOCl 1.6×10³ mol⁻¹min⁻¹ (Edwards and Pearson, 1962; Jencks and Carriuolo, 1960) clearly indicate that peroxide has higher absorption kinetics compared to hypochlorite. A similar trend was observed in the case of CO₂ absorption kinetics with H₂O₂ and NaOCl as shown in FIG. 3, which supports the theory. Few researchers have previously tested ClO₂ and CO₃ as well. Without wishing to be bound by theory, it is believed that the reason that ClO functions as a oxygen atom in ClOₙ occurs at a faster rate with a lower n value and thus Cl having a lower oxidation state. Overall H₂O₂ gave slightly better kinetics compared to NaOCl as shown in FIG. 3.

Although the present inventors have not performed liquid analysis, depending on the molar ratio of CO₂ converted and sodium carbonate used (0.2 mol/L), the fraction of sodium carbonate converted to bicarbonate is only 0.45 without the rate promoter, due to slower absorption kinetics. The conversion increased to 82% after the addition of the rate promoter, which corresponds to an increase of 45.1%.

### NO Absorption

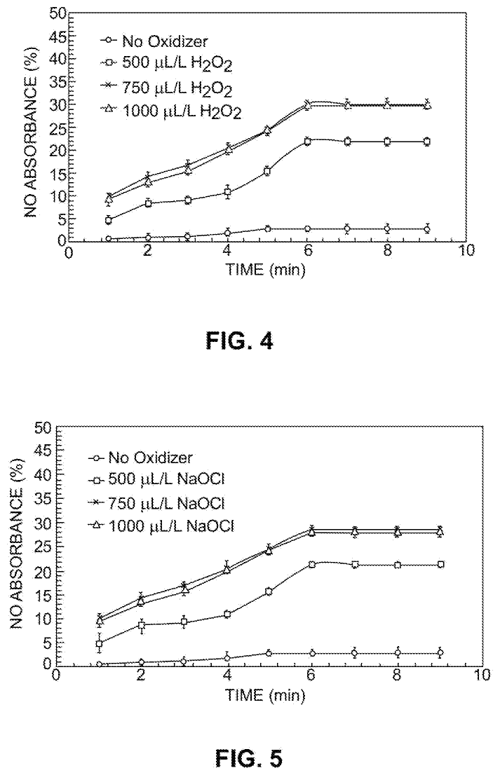

FIGS. 4 and 5 show the percentage absorbance of NO in 0.2 mol/L Na₂CO₃ solution enhanced with 500 to 1500 μL/L H₂O₂ and NaOCl respectively. The percentage of absorbance reached 10% in the first 1 min with the addition of H₂O₂ and finally reaching 31% in 5 min after reaching steady state. The percentage of absorbance reached 9% in the first 1 min with the addition of NaOCl and finally reaching 29% in 5 min after reaching steady state. The NO absorption efficiency increased with increase in oxidizer concentration from 500 to 750 μL/L. The absorbance increased only slightly thereafter and reached an asymptotic maximum at 1000 μL/L concentration. It can be noted that H₂O₂ gave better absorption kinetics than NaOCl, which is discussed in detail below. The absorption performance of both rate promoters is limited at ambient conditions in the absence of a heterogeneous catalyst. The present inventors were able to achieve 30.2% absorbance with 0.2 mol/L Na₂CO₃ solution+1000 μL/L H₂O₂ at pH 11.45 and temperature 318 K.

Since the NO oxidation reaction is limited after a certain value at 318 K, increasing temperature might increase the absorption performance, but due to other mixed gases and physical limitations of the system, the inventors could not increase the temperature of the absorbent solution. One other possibility is adding a heterogeneous catalyst like platinum to reduce the activation energy and promote the reaction rate at 318 K.

Also, pH plays a crucial role in limiting the NO absorption efficiency of the solution. At pH of about 11.5, the reaction tends to limit itself after certain interfacial concentration is reached. As such, the absorbance stopped at 30.2%. In retrospect, NO oxidation continues to increase with increased oxidizer at lower pH values of around 5.

### NO Absorption Kinetics

The absorption rate of NO can be expressed by Equation 23, based on the gas-liquid mass transport theory proposed by Dackwerts and Lannus (1970).

$${R}_{NO} = \sqrt{\frac{2}{m + 1} \times {k}_{m , n} \times {D}_{NO} \times {c}_{NO}^{m + 1} \times {c}_{NaOCl}^{n}} \qquad ( 23 )$$

where R_{NO} is the rate of absorption of NO, k_{m,n} is the rate constant and D_{NO} is the diffusion coefficient of NO in water, which can be considered as 2.076×10⁻⁹ m²/sec at 318 K. C_{NO} is the interfacial concentration of NO, which can be obtained from Equation 16. Baveja et al. (1979) studied the absorption kinetics of nitric oxide in hydrogen peroxide solution and concluded that first order kinetics followed. The reaction was found to follow first order kinetics with NaOCl as well. So, the values of m, n are considered to be m=1 and n=1. The rate constant was estimated from Arrhenius equation, where the activation energy (Eₐ) and frequency factor (A) are Eₐ=57.3 kJ/mol, A=6.52×10⁹ m³/(mol·sec) and Eₐ=28.15 kJ/mol, A=7.96×10⁸ m³/(mol·sec) for H₂O₂ and NaOCl, respectively (Baveja et al., 1979; Deshwal and Kundu, 2015).

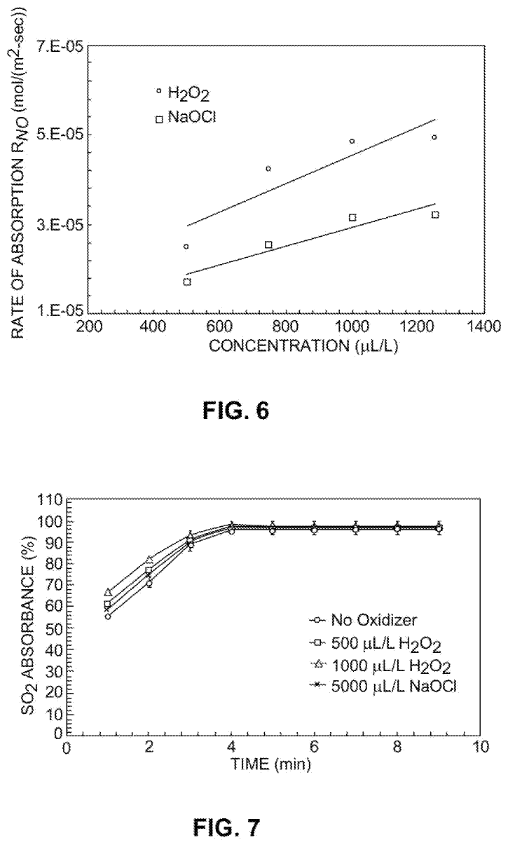

The effect of oxidizer concentration on the rate of absorption of NO at 318 K and 0.2 mol/L Na₂CO₃ concentration can be seen in FIG. 6. The rate of absorption of NO initially increases with increasing oxidizer concentration and attains a steady state after 1000 μL/L for both NaOCl and H₂O₂. This can be attributed to the fact that rate constant reaches a limiting value at higher PH levels beyond certain concentration of the rate promoter (Deshwal and Kundu, 2015). At pH 10 the absorption efficiency decreases due to decrease in oxidizing potential of the catalyst. A slowdown of absorption of NO was observed because of the decrease in oxidizing ability of NaOCl at higher pH values. The potential for the half cell reaction of NaOCl in alkaline pH conditions can be seen in Equation 24 below:

ClO₋+2H₊+2e₋=Cl₋+H₂O Eₒ=1.48 V (24)

where E^{o} is the standard oxidation potential. According to Nernst equation higher H+ concentration implies higher potential (E) and hence higher oxidizing ability. So, at higher pH values the oxidizing power reduces rapidly. Concentration of Na₂CO₃ also has a direct effect on NO absorption efficiency. With increase in Na₂CO₃ concentration from 0.2 to 0.3 mol/L the rate of reaction of NO drastically reduced. Wei et al. (2009) have also observed reduced NO absorption rate with increase in sodium carbonate concentration from 0.01 to 0.05 mol/L with NaClO₂ as the rate promoter. The same applies for other alkal absorbent solutions as well. In case of NaOH as the absorbent solution Sada et al. (1978) have observed an exponential decrease in rate of reaction.

### SO₂ Absorption

Since the reactions (10)-(13) are almost instantaneous, the rate of absorption of SO₂ is very high compared to CO₂ and NO in aqueous medium. FIG. 7 shows the absorbance of SO₂ in 0.2 mol/L Na₂CO₃ solution enhanced with H₂O₂/NaOCl. The absorbance reached 65% in the first 1 min and finally reaching 97% in 5 min after reaching steady state. The oxidizer did not show any major effect. Absorbance reached 95% very fast, hitting a maximum value of 96.2%. The rate promoters show almost negligible/minimal effect on absorption performance of SO₂ in aqueous Na₂CO₃ solution. These rate promoters do increase the absorbance of SO₂ but since it is already readily absorbed, this difference is minute. Presence of NO₂ from NO oxidation have not shown any significant effect on the absorption performance of SO₂.

Effect of Solution pH on Absorption Efficiencies of CO₂, NO and SO₂

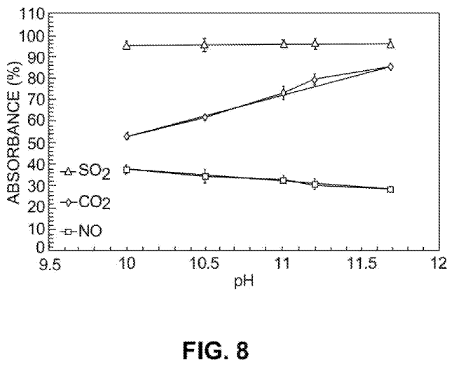

Initial pH of the absorbent solution plays a crucial role in determining the mass transfer rate of gases into liquids. The pH of the solution was varied from 10.62 to 11.73 by changing the Na₂CO₃ concentration. FIG. 8 shows the effect of pH on the absorbance of all the three gases at 750 μL/L H₂O₂ concentration after 5 min of reaching steady state. The absorbance of SO₂ remained mostly unaffected, while that of CO₂ reduces rapidly at lower pH values due to low H₊ buffering capacity of the solution. The absorption efficiency for NO increases slightly at lower pH values. As evidenced by previous literature, where they studied NO absorption in acidic pH and observed that with increase in pH, absorption lowered.

Few researchers have previously studied the NO absorption characteristics in acidic pH conditions and observed a decrease in NO oxidation rate with increased pH (Baveja et al., 1979; Deshwal et al., 2008b; Krzyzynska and Hutson, 2012; Myers and Overcamp, 2002). The present inventors have observed quite a similar trend in our study in the pH range of 10 to 12, where the rate of absorption of NO decreased with increased pH, because of the weak ability of H₂O₂/NaOCl to act as an oxidizer in alkaline conditions. Since the primary goal of this unit is to capture CO₂, operating at a pH of 11.6 or higher is ideal.

While the scrubber system of the present invention may not be a substitute for current SCR, it can definitely be used in industrial flue gas treatment with lower concentrations of NOₓ and SOₓ. It is also suggested that wherever the NOₓ percentage is higher, an additional scrubbing column should be included in series combination with the original scrubber, so that whatever NOₓ is left unabsorbed in the first column is absorbed by the second column.

The present invention illustrates that it is possible to capture CO₂, NO and SO₂ with a single scrubbing column. The efficacy of the system is clearly higher with a CO₂ absorption efficiency of 99.7%, compared to previous studies on CO₂ capture using low cost dilute sodium carbonate solution. Absorbance of CO₂ in a sodium carbonate scrubber column increased from 61% to 99.7% after the addition of H₂O₂ or NaOCl. NO was also absorbed, but was limited by the alkaline pH to less than 31% absorbance. Lowering the pH decreased CO₂ absorption while increasing NO absorption. Excessive supply of oxidizer did not improve the absorption efficiency of NO. SO₂ absorption reached 95% almost instantaneously, with or without the addition of oxidizer. H₂O₂ acted as better rate enhancing agent than NaOCl. Enhancing the dilute sodium carbonate solution with H₂O₂ increases its CO₂ absorption performance reducing the need for additional alkaline reagent.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

1. A method for the simultaneous capture of CO₂, NOₓ and SOₓ from flue gas to generate a clean gas, the method comprising:
providing a single stage absorption column;
flowing a scrubbing solution through the single stage absorption column from a scrubbing solution inlet to a scrubbing solution outlet, wherein the scrubbing solution comprises sodium carbonate and at least one oxidizer; and
flowing flue gas through the single stage absorption from a flue gas inlet to a flue gas outlet;
wherein the scrubbing solution is capable of removing CO₂, NOₓ and SOₓ from the flue gas, such that the scrubbing solution has an absorbance of CO₂ of at least 95%, NO of at least 25%, and SO₂ of at least 90%.

2. A scrubber system for the simultaneous capture of CO₂, NOₓ and SOₓ from flue gas to generate a clean gas, the scrubber system comprising:
a single stage absorption column having a scrubbing solution inlet, a flue gas inlet, a scrubbing solution outlet and a flue gas outlet;
a scrubbing solution flowing through the single stage absorption column from the scrubbing solution inlet to the scrubbing solution outlet, wherein the scrubbing solution comprises sodium carbonate and at least one oxidizer; and
a flue gas flowing through the single stage absorption column from the flue gas inlet to the flue gas outlet;
wherein the scrubbing solution is capable of removing CO₂, NOₓ and SOₓ from the flue gas as the flue gas flows from the flue gas inlet to the flue gas outlet, such that the flue gas located proximate the flue gas outlet has at least 95% CO₂, at least 25% NO, and at least 90% SO₂ simultaneously removed by the scrubbing solution.

3. (canceled)

4. The method of claim 1, wherein the absorbance is at least 99% for CO₂.

5. The method of claim 1, wherein the absorbance is at least 28% for NO.

6. The method of claim 1, wherein the absorbance is at least 92% for SO₂.

7. The method of claim 1, wherein the absorbance is 99.5% for CO₂, at least about 29% for NO, and at least about 93% for SO₂.

8. The method of claim 1, wherein, the absorbance is up to about 100% for CO₂, up to about 50% for NO, and up to about 99% for SO₂.

9. The method of claim 1, wherein the single stage absorption column at alkaline pH conditions comprises a counter-current absorption column.

10. The method of claim 1, wherein the sodium carbonate solution having a concentration between about 0.1 mol/L and about 0.4 mol/L.

11. The method of claim 1, wherein the at least one oxidizer is chosen from the group consisting of H₂O₂, NaOCl, NaOCl₂, NaClO₃, and mixtures thereof.

12. The method of claim 1, wherein the at least one oxidizer is H₂O₂, NaOCl, or a mixture thereof.

13-14. (canceled)

15. The method of claim 1, wherein the one oxidizer is present in the scrubbing solution in an amount between about 650 μL/L and about 850 μL/L.

16. (canceled)

17. The method of claim 1, wherein the scrubbing solution is provided at a pH in the rage of about 8 to about 13.

18. The method of claim 1, wherein flue gas inlet has a temperature between about 34° C. and about 50° C.

19. The method of claim 1, wherein a ratio of the scrubbing solution to flue gas in the single stage absorption column is between about 3 and about 4.8.

20. The method of claim 1, wherein a scrubbing solution flow rate is between about 1.5 gallons/minute and about 2.5 gallons/minute.

21. The method of claim 1, wherein the single stage absorption column further comprising a packing material.

22. The method of claim 21, wherein the packing material comprises pall rings.

23. The method of claim 22, wherein the pall rings comprise polypropylene, polyvinylidene fluoride (PVDF), high-density polyethylene (HDPE), glass filled polypropylene, polyvinyl chloride (PVC), and combinations thereof.

24. The method of claim 1, wherein the scrubbing solution is essentially devoid of a rate-enhancing agent chosen from piperazine (PZ), monoethanolamine (MEA), boric acid, carbonic anhydrase (CA) and polyglycol ethers.

25-26. (canceled)
